(19) United States
(12) Patent Application Publication
(10) Pub. No.: US 2012/0212945 A1
(43) Pub. Date: Aug. 23, 2012

(54) Light fixture

(76) Inventor: Frank Keery Frank, Scottsdale, AZ (US)

(21) Appl. No.: 13/385,442

(22) Filed: Feb. 21, 2012

Related U.S. Application Data
(60) Provisional application No. 61/463,865, filed on Feb. 22, 2011.

(51) Int. Cl. F21L 4/02; F21V 7/00; F21V 1/00; F21V 29/00

(52) U.S. Cl. 362/184

(57) ABSTRACT

The present invention is a novel Light Emitting Diode (LED) light fixture. The fixture is comprised of a number of basic components. Namely, a junction box with integral mounting hook and internal mounting plate; at least one electronic drivers/power supplies mounted in the junction box; at least one heat sink; at least two printed circuit boards depending upon customer lighting requirements; at least two reflectors depending upon the number of PCBs utilized in any one fixture; and a shield to mechanically protect the reflectors in handling and installation.

### TECHNICAL FIELD

The present disclosure relates to a novel light fixture. More specifically the present invention relates to a modularized Light Emitting Diode fixture that is useful in commercial and industrial settings.

### BACKGROUND

While the trend to replace existing lighting systems with Light Emitting Diode (LED) products is certainly growing rapidly, there has been noticeably less of this in high lumen output lighting apparatus due primarily to the state-of-the-art in LED technology and resultant high costs. LEDs are just now reaching the kind of elevated lighting level capability that are needed for applications like warehouse lighting and big box retailers. There are products on the market for these applications but they are either woefully inadequate in terms of light intensity (lumens) or they are too expensive to really be widely adopted.

A problem with the existing product that is serving this market segment aside from cost is that they are very inflexible in their design and can't adapt to the myriad of application parameters one finds in warehouses & big box retailers.

These applications are characterized by:
a) widely variable center to center light fixture spacing
b) widely variable fixture mounting heights
c) widely variable customer lighting level requirements

Existing LED products on the market are singular designs with fixed number of LEDs and basic fixture geometry. Often, a specific customer's requirements does not fit into one of the existing, fixed parameters of a competitive product, consequently, the customer is forced to accept whatever compromised configuration that is being offered or excessive costs for rewiring to accommodate existing electrical configuration. The result is a choice between an excessively high price and/or compromised performance. The existing designs just don't lend themselves to accommodating what the customer's facilities truly require. If they reduce the number of LEDs in their fixed designs, they may meet the reduced level of light lumen output but they destroy the efficiency of the system optics and greatly reduce ultimate system effectively.

Thus, there is a present and continuing need for a “modular” LED light fixture that can easily and cost effectively be adapted to the customer's requirements as opposed to the customer having to accept what the industry has to sell.

### SUMMARY

It is an object of the present invention to provide a novel Light Emitting Diode (LED) fixture.

It is another object of the present invention to provide a novel LED fixture that has an adaptable fixture design in the choice of number and light intensity of Printed Circuit Boards (PCBs) to be utilized by controlling the number and type of LEDs mounted on each PCB and the number of such PCBs utilized in any given fixture design.

It is yet another object of the present invention to provide a novel LED fixture that has a choice of a number of different reflectors sets used in conjunction with each PCB creating a variety of fixture beam angle light controls.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE FIGURES

FIG. 1 shows an exploded view of the present invention.

FIG. 2 shows a side view of the present invention.

FIG. 3 shows a bottom view of the present invention.

FIG. 4 shows an canted bottom view of the present invention.

FIG. 5 shows a canted side view of the present invention.

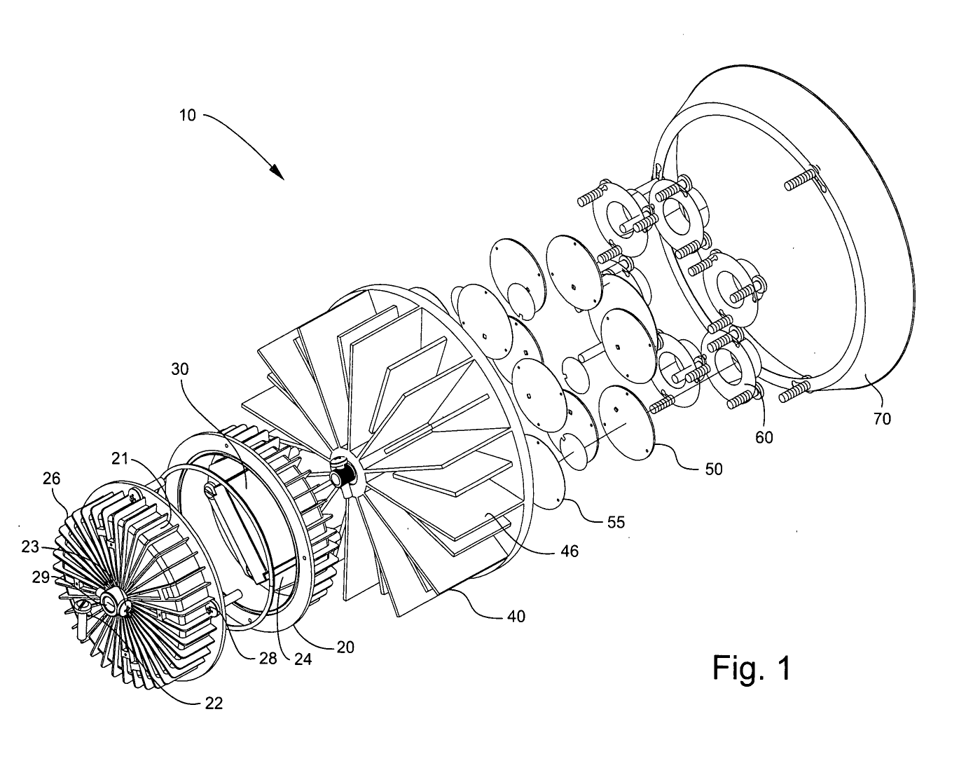

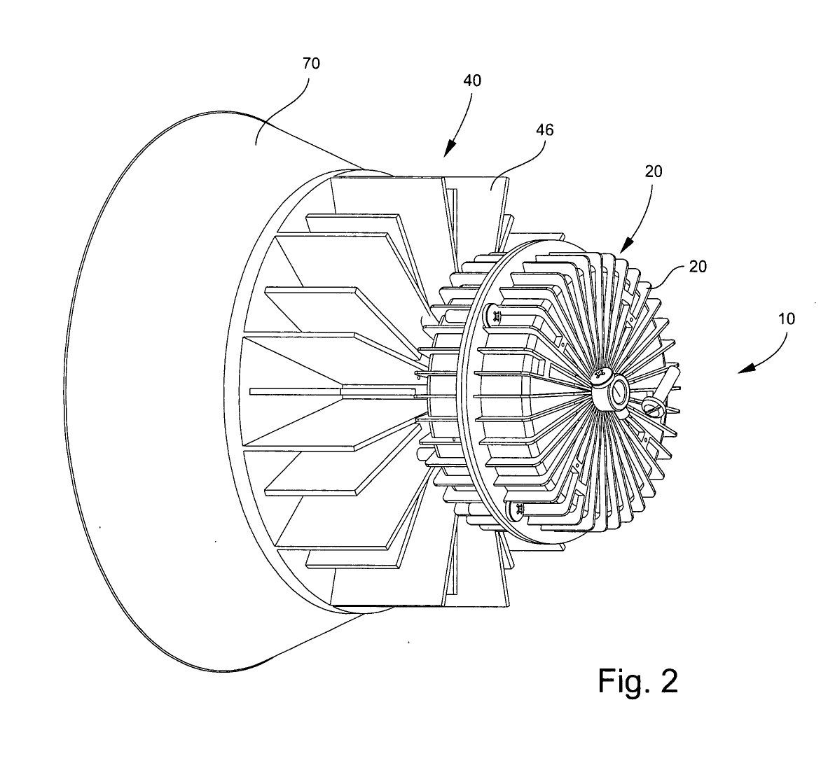

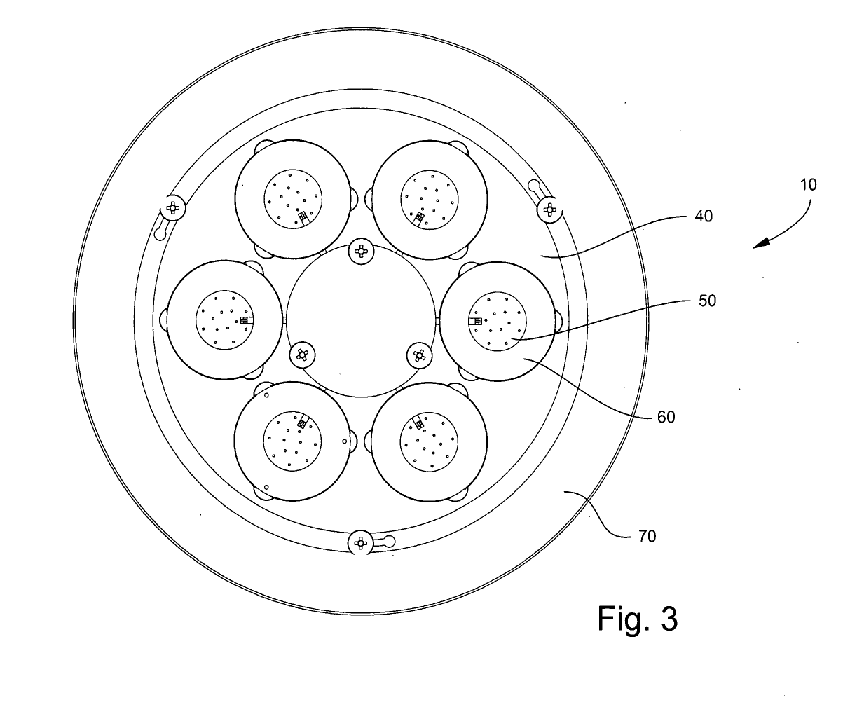

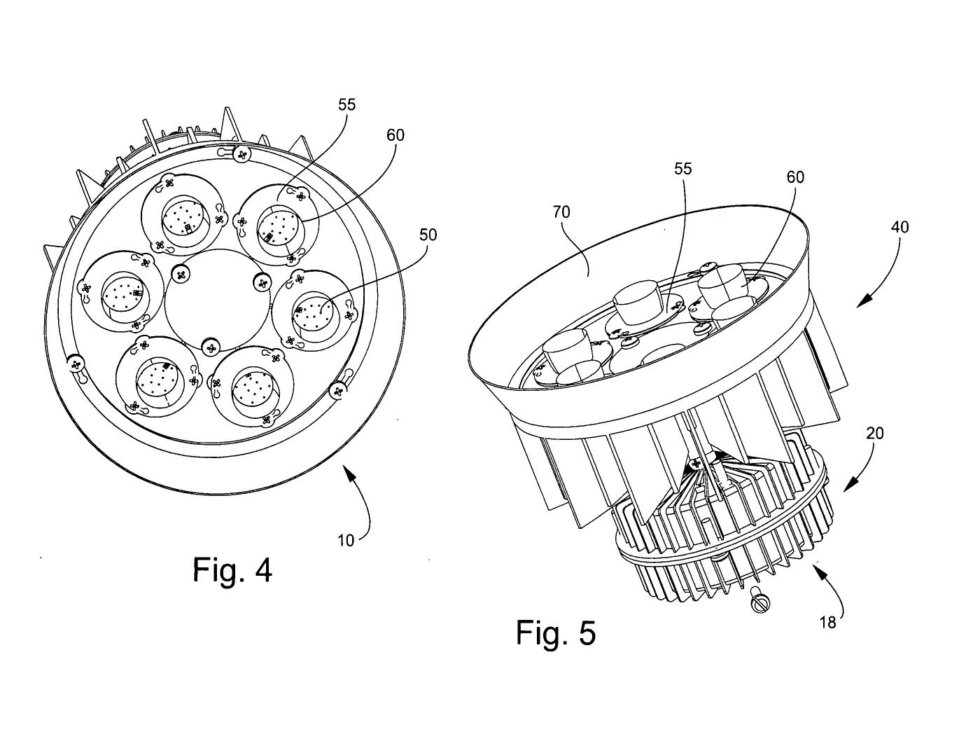

### DETAILED DESCRIPTION

The present invention is a novel Light Emitting Diode (LED) light fixture 10. The fixture 10 is comprised of a number of basic components. Namely, a junction box 20 with integral mounting hook 22 and internal mounting plate 24; at least one electronic drivers/power supplies 30 mounted in the junction box 20; at least one heat sink 40; at least two printed circuit boards 50 depending upon customer lighting requirements; at least two reflectors 60 depending upon the number of PCBs utilized in any one fixture; and a shield 70 to mechanically protect the reflectors in handling and installation.

The junction box 20 of the fixture 10 is adapted to house the LED power supplies 30 and to accommodate the entrance and interconnection of the fixture 10 to a facility electrical power system. It has a primary wall 21 is constructed with a plurality of fins 26 all over its exterior so that heat generated inside from the driver/power supplies 30 is safely transmitted from the inside of the junction box 20, through the primary wall 21, through the fins 26 and out into the atmosphere. At the top of the junction box 20 is mounting system 22, such as a hook with a safety set screw 23 to ensure that a customer mounting apparatus (normally an eye of a chain link) will not slip off of the hook. The hook mounting system 22 is attached to a top end of the junction box 20 by screwing integral threads, located at one end of the hook mounting system 22, into a complementary threaded aperture in the top of the junction box 20. Preferably, there is an access hole 29 in the middle of the hook mounting system 22 to allow an incoming power cable to enter the junction box 20 while providing a water tight seal. There are set screws 23 in the top and bottom of the junction box 20 to ensure that the hook mounting system 22 at the top and the heat sink 40 at the bottom of the junction box 20 remain securely fastened through time, usage, heat/cooling, and the like. Alternatively the junction box 20 may be hard mounted a surface. The junction box 20 is preferably made of aluminum and finished by powder coating, painting or anodizing.

Inside the junction box 20, there is a mounting plate 24 to which the driver/power supplies 30 are attached. This mounting plate 24 is screwed into and offset from the bottom of the junction box 20 so any incoming wires are provided clearance space. The mounting plate 24 also acts as another direct conductor of heat generated by the driver/power supplies to the junction box walls 21.

Located preferably inside the junction box 20 is at least one driver/power supply 30 that essentially power the LEDs mounted on printed circuit boards (PCB), as is more fully described below. The at least one driver/power supply 30 is modular and multiples of them may be used depending upon how many LEDs are utilized in any specific fixture.

Each driver/power supply 30 is built to accommodate a range of incoming alternating current voltages typically from 90 VAC to 300 VAC. The output of the driver/power supply 30 typically ranges from 40 to 50 volts direct current (VDC); can light at least one PCB, each independently of the other; has a temperature set back feature, where when the external temperature reaches a preset point, the power supplied is reduced to prevent thermal burn-out of the units; has a linear response to input thereby making them functional with exiting dimming technology; and has occupancy sensing compatibility.

Preferably the driver/power supplies 30 are electronic in nature and are designed to automatically shut down if input or output parameters exceed the values for which they were designed. In such cases, after a brief period, the units reset themselves assuming that the off specification parameters have been removed.

Connection to the input side of the driver/power supplies 30 is accomplished by the use of simple wire interconnection devices connecting the two driver/power supplies 30 input wires to the incoming facility power wires. The two output wires from the driver/power supplies 30 have simple connectors already attached to the wire ends that will connect with the mating connectors attached to the printed circuit wires entering from the lower neck of the junction box 20. Preferably the driver/power supplies 30 are screw connected to the internal junction box mounting plate. The preferred driver/power supplies 30 are designed to have a minimum life of 50,000 hours when operated within the specified use and approximate operating temperature maximum of 150° F.

A large heat sink 40 is connected to the bottom of the junction box 20. The heat sink 40 accommodates the printed circuit boards 50 by providing a mounting surface on its bottom and even more importantly it performs the critical function of drawing away the majority of the heat generated by the LEDs when they are electrified and then dissipates this heat into the atmosphere. Thermal management of LED (light emitting diode) junction temperatures is critical to preserving the life and functioning of the LED.

The top of the heat sink 40 is designed with screw threads to accommodate attachment to the bottom neck of the junction box 20. There is a hole through the center of the heat sink 40 to provide a channel for the printed circuit wires to travel from the PCB interface up to the driver units output wires.

The bottom of the heat sink 40 has several small threaded holes for attachment of the various PCB light engines, a circular wire cover and an exterior shield.

The body of the heat sink 40 is designed with a multiplicity of narrow fins 46 designed to produce the maximum amount of cooling surface area. In one embodiment, the fins 46 may have at least one aperture in each fin 46 thereby increasing the convection around the fin and increasing the thermal dissipation. Heat generated by the PCB light engines is conducted into the heat sink 40 which in turn dissipates this heat into the ambient atmosphere through the heat sink fin 46 surfaces. The heat sink fins 46 are designed with longer and shorter fins to accommodate maximum flow of ambient air across the heat sink 40 surfaces to carry away unwanted heat. The bottom of the heat sink 40 is rendered very smooth through secondary operation(s) to ensure maximum thermal contact surface area between PCB light engines and the heat sink 40. Thermal heat transfer pads are utilized between the PCB light engines and the heat sink 40 bottom to minimize heat resistance between the aluminum PCB substrate and the bottom of the heat sink 40. The thermal resistance of the thermal pads are usually only a few degrees Kelvin per watt.

Circular printed circuit boards 50 are mounted to the bottom of the heat sink 40 with thermal heat transfer pads to decrease thermal resistance and to guarantee a good thermal conductance between the PCBs 50 and the heat sink 40. There are usually 68 LEDs on each PCB 50. The number of PCBs 50 utilized can vary between one and six depending upon specific customer lighting requirements. The PCBs 50 are constructed of thin, chemically etched copper pattern tracks sandwiched between two very thin layers of insulating material. Access holes are produced in the top insulating layer of the PCB 50 to allow access for the LED light. The bottom insulating layer of the PCB 50 is in intimate contact with an aluminum PCB substrate 55 usually accomplished with a thin layer of high temperature adhesive. The thermal resistance between the bottom insulating layer of the PCB 50 and the aluminum PCB substrate 55 must be minimized to only a few degrees Kelvin per watt to ensure good heat transfer. The aluminum PCB substrate 55 is larger in diameter than the PCB printed circuits and insulating layers in order to facilitate the interconnection of light reflectors around each PCB.

Reflectors 60 are mounted onto each PCB 50 such that the resultant light emanating from the LEDs is captured and focused down onto the area to be lighted below. There are multiple reflector design sets that in conjunction with multiples of PCBs allow the total adaptation of the fixture 10 to customer requirements. The light reflectors 60 also serve as heat dissipaters carrying unwanted heat generated by the LEDs to the atmosphere through their thin aluminum walls. To achieve various beam angle light management, there are several different designs of reflectors 60, usually 40, 60, 90, 120 & 150 degree beam angles. By choosing any one of these reflector designs and mounting one of them onto the PCB substrate 55, one has created a specific light engine adapted for a specific customer facility requirement. Beam angle variations are driven by facility parameters such as lighting fixture mounting height, spacing between the multiplicity of fixtures, desired light levels below the lighting fixtures, reflectivity of facility surfaces like the floors, walls, ceilings, and the like.

Preferably the inside surface of the reflectors 60 is plated or coated with a very highly reflective material to maximize the amount of light generated by the light engines that ultimately exits the fixture to the desired surfaces below. Reflectivity levels of 85% to 95% are typical.

Reflector 60 shapes and dimensions are typically computer designed for optimum light pattern management. The generic reflector shape presently envisioned for utilization in this fixture design is parabolic in nature. Other geometric shapes could also potentially be utilized.

An aluminum shade 70 mounted to the bottom of the heat sink 40 is utilized to protect the reflectors 60 from mechanical damage during handling and installation. The shade 70 could be of a solid construction or take on a wire guard design either of which designs provides protection of the more fragile reflectors 60 during shipping, handling, installation and use.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A Light Emitting Diode (LED) light fixture comprising: a junction box with an integral mounting hook and internal mounting plate; at least one LED electronic drivers/power supplies mounted in the junction box; at least one heat sink; at least two printed circuit boards (PCBs); at least one reflector depending upon the number of PCBs utilized in any one fixture; and at least one shield to mechanically protect the at least one reflector during handling and installation, wherein
a. The junction box of the fixture is adapted to house the LED power supplies and to accommodate the entrance and interconnection of the fixture to a facility electrical power system; the junction box comprises a primary wall constructed with a plurality of fins all over its exterior so that heat generated inside from the driver/power supplies is safely transmitted from the inside of the junction box, through the primary wall, through the fins and out into the atmosphere, a top of the junction box is a hook mounting system with a safety set screw to ensure that a customer mounting apparatus will nonslip off of the hook, the hook mounting system is attached to the top end of the junction box by screwing integral threads, located at one end of the hook mounting system, into a complementary threaded aperture in the top of the junction box, there is an access hole in the middle of the hook mounting system to allow an incoming power cable to enter the junction box while providing a water tight seal, there are set screws in the top and in a bottom of the junction box to ensure that the hook mounting system at the top and the heat sink at the bottom of the junction box remain securely fastened through time, usage, heat/cooling, and the like;
b. inside the junction box there is a mounting plate to which the LED driver/power supplies are attached, this mounting plate is screwed into and offset from the bottom of the junction box so any incoming wires are provided clearance space, the mounting plate also acts as another direct conductor of heat generated by the LED driver/power supplies to the junction box walls;
c. located inside the junction box are LED driver/power supplies that power LEDs mounted on each PCB, the LED driver/power supplies are modular and multiples of them are utilized depending upon how many PCB/LEDs are utilized in any specific fixture, electrical connection to the input side of the LED driver/power supplies is accomplished by the use of simple wire interconnection devices connecting the two LED driver/power supplies input wires to the incoming facility power wires, the two output wires from the LED driver/power supplies have simple connectors already attached to the wire ends that will connect with the mating connectors attached to PCB wires entering from the lower neck of the junction box;
d. a large heat sink is connected to the bottom of the junction box, the heat sink accommodates the PCBs by providing a mounting surface on its bottom and even more importantly it performs the critical function of drawing away the majority of the heat generated by the LEDs mounted on the PCBs when they are electrified and then dissipates this heat into the atmosphere, the top of the heat sink is designed with screw threads to accommodate attachment to the bottom neck of the junction box, there is a hole through the center of the heat sink to provide a channel for the PCB wires to travel from the PCB interface up to driver units output wires, the bottom of the heat sink has several small threaded holes for attachment of the various PCBs, a circular wire cover and an exterior shield, the body of the heat sink is designed with a multiplicity of narrow fins designed to produce the maximum amount of cooling surface area, the heat sink fins are designed with longer and shorter fins to accommodate maximum flow of ambient air across the heat sink surfaces to carry away unwanted heat, the bottom of the heat sink is rendered very smooth to ensure maximum thermal contact surface area between PCBs and the heat sink, thermal heat transfer pads are utilized between the PCBs and the heat sink bottom to minimize thermal resistance between the PCB substrate and the bottom of the heat sink;
e. the printed circuit boards are mounted to the bottom of the heat sink, have at least one LED on each PCB, the PCBs are constructed of thin, chemically etched copper pattern tracks sandwiched between two very thin layers of insulating material, access holes are produced in a top insulating layer of the PCB to allow access for each LED light, a bottom insulating layer of the PCBs is in intimate contact with a PCB substrate usually accomplished with a thin layer of high temperature adhesive, the PCB substrate is larger than the PCBs and insulating layers in order to facilitate the interconnection of light reflectors around each PCB;
f. the reflectors are mounted onto each PCB such that the resultant light emanating from the PCBs is captured and focused down onto the area to be lighted below, the reflectors also serve as heat dissipaters carrying unwanted heat generated by the PCBs to the atmosphere through their thin walls; and
g. each shade is mounted to the bottom of the heat sink and is utilized to protect the reflectors from mechanical damage during handling and installation.

2. The Light Emitting Diode (LED) light fixture according to claim 1 wherein the LED driver/power supplies are built to accommodate a range of incoming alternating current voltages typically from 90 VAC to 300 VAC, the output of the LED driver/power supplies typically ranges from 40 to 50 volts direct current (VDC), and the LED driver/power supplies are electronic in nature and are designed to automatically shut down if input or output parameters exceed the values for which they were designed, whereby after a brief time period, the LED driver/power supplies reset themselves assuming that the off specification parameters have been removed.

3. The Light Emitting Diode (LED) light fixture according to claim I where the shade is of a solid construction or a wire guard design, either of which designs provides protection of the more fragile reflectors during shipping, handling, installation and use.

4. A Light Emitting Diode (LED) light fixture comprising: a junction box; at least one LED electronic drivers/power supplies mounted in the junction box; at least one heat sink thermally connected between the junction box and the at least one LED electronic drivers/power supplies; at least one printed circuit boards (PCBs) electrically connected to the at least one LED electronic drivers/power supplies and thermally connected to the heat sink, at least one reflector attached around the at least one PCB; and at least one shield attached around the at least one reflector to mechanically protect the at least one reflector.

5. The Light Emitting Diode (LED) light fixture according to claim 4 wherein the junction box of the fixture is adapted to house the at least one LED power supplies and to accommodate the entrance and interconnection of the fixture to a facility electrical power system; the junction box comprises a primary wall constructed with a plurality of fins all over its exterior so that heat generated inside from the driver/power supplies is safely transmitted from the inside of the junction box, through the primary wall, through the fins and out into the atmosphere, a top of the junction box having a hook mounting system with a safety set screw to ensure that a customer mounting apparatus will not slip off of the hook, the hook mounting system attached to the top end of the junction box by screwing integral threads, located at one end of the hook mounting system, into a complementary threaded aperture in the top of the junction box, an access hole in the middle of the hook mounting system to allow an incoming power cable to enter the junction box while providing a water tight seal, set screws in the top and in a bottom of the junction box to ensure that the hook mounting system at the top and the heat sink at the bottom of the junction box remain securely fastened through time, usage, heat/cooling, and the like.

6. The Light Emitting Diode (LED) light fixture according to claim 4 wherein the junction box further comprises an integral mounting hook and internal mounting plate.

7. The Light Emitting Diode (LED) light fixture according to claim 4 wherein inside the junction box is a mounting plate to which the at least one LED driver/power supplies are attached, the mounting plate is screwed into and offset from a bottom of the junction box so any incoming wires are provided clearance space, the mounting plate also acts as another direct conductor of heat generated by the LED driver/power supplies to walls of the junction box walls.

8. The Light Emitting Diode (LED) light fixture according to claim 4 wherein located inside the junction box are LED driver/power supplies that power LEDs mounted on each PCB, the LED driver/power supplies are modular and multiples of them are utilized depending upon how many PCB/LEDs are utilized in any specific fixture, electrical connection to the input side of the LED driver/power supplies is accomplished by the use of simple wire interconnection devices connecting the two LED driver/power supplies input wires to the incoming facility power wires, the two output wires from the LED driver/power supplies have simple connectors already attached to the wire ends that will connect with the mating connectors attached to PCB wires entering from a lower neck of the junction box.

9. The Light Emitting Diode (LED) light fixture according to claim 4 wherein the heat sink is connected to a bottom of the junction box, the heat sink accommodates the PCBs by providing a mounting surface on its bottom and even more importantly it performs the critical function of drawing away the majority of the heat generated by the LEDs mounted on the PCBs when they are electrified and then dissipates this heat into the atmosphere, a top of the heat sink is designed with screw threads to accommodate attachment to a bottom neck of the junction box, there is a hole through the center of the heat sink to provide a channel for PCB wires to travel from the PCB interface up to driver units output wires, the bottom of the heat sink has several small threaded holes for attachment of the various PCBs, a circular wire cover and an exterior shield, the body of the heat sink is designed with a multiplicity of narrow fins designed to produce the maximum amount of cooling surface area, the heat sink fins are designed with longer and shorter fins to accommodate maximum flow of ambient air across the heat sink surfaces to carry away unwanted heat, the bottom of the heat sink is rendered very smooth to ensure maximum thermal contact surface area between PCBs and the heat sink, thermal heat transfer pads are utilized between the PCBs and the heat sink bottom to minimize thermal resistance between the PCB substrate and the bottom of the heat sink.

10. The Light Emitting Diode (LED) light fixture according to claim 4where the printed circuit boards are mounted to a bottom of the heat sink, have at least one LED on each PCB, constructed of thin, chemically etched copper pattern tracks sandwiched between two very thin layers of insulating material, access holes produced in a top insulating layer of each PCB to allow access for each LED light, a bottom insulating layer in intimate contact with a PCB substrate usually accomplished with a thin layer of high temperature adhesive, the PCB substrate is larger than the PCBs and insulating layers in order to facilitate the interconnection of the light reflectors around each PCB.

11. The Light Emitting Diode (LED) light fixture according to claim 4 wherein the reflectors are mounted onto each PCB such that the resultant light emanating from the PCBs is captured and focused down onto the area to be lighted below, the reflectors also serve as heat dissipaters carrying unwanted heat generated by the PCBs to the atmosphere through their thin walls.

12. The Light Emitting Diode (LED) light fixture according to claim 4 wherein each shade is mounted to the bottom of the heat sink and is utilized to protect the reflectors from mechanical damage during handling and installation, each shade is of a solid construction or a wire guard design, either of which designs provides protection of the more fragile reflectors during shipping, handling, installation and use.
